(19) United States
(12) Patent Application Publication
(10) Pub. No.: US 2019/0139171 A1
(43) Pub. Date: May 9, 2019

(54) Cloud Integrated School Scheduling System

(71) Applicant: Assaf Cohen-Arazi, San Diego, CA (US)

(72) Inventor: Assaf Cohen-Arazi, San Diego, CA (US)

(21) Appl. No.: 16/127,925

(22) Filed: Sep. 11, 2018

Related U.S. Application Data
(60) Provisional application No. 62/556,856, filed on Sep. 11, 2017.

(51) Int. Cl. G06Q 50/20; H04L 29/08

(52) U.S. Cl. CPC G06Q 50/2053; H04L 67/1097

(57) ABSTRACT

Disclosed is an online system, available on any mobile device and Web Browser, which introduces a new way to build a school schedule. It introduces a user interface with the ability to read data files from the school's website and parse it to an internal data structure. A user of this system can then search available classes, build a multi-year plan, validate the plan using the system's predefined rules and share it with school counselor. The user can also use the system to track school and university credit and make sure the plan is on track with student's goal.

### RELATED APPLICATIONS

This application claims priority to the United States Provisional Patent Application for “Cloud Integrated School Scheduling System,” Ser. No. 62/556,856, filed Sep. 11, 2017, and currently co-pending.

### FIELD OF THE INVENTION

The present invention pertains generally to a scheduling aid. More specifically, the present invention pertains to a school schedule planning system which parses a school's schedule and aids a student in selecting courses with a set of pre-defined rules and an intuitive user interface. The present invention is particularly, but not exclusively, useful as an aid for efficient preparation of an individualized education plan.

### BACKGROUND

Educational institutions, such as schools, colleges, and universities, often provide their class schedule in a plain document form like HTML, PDF and various other formats. The schedule is then used by the students to build their multi-year plan. The process of building a multi-year plan is iterative, complicated, error prone, and tedious as the students need to use the school's provided files, which are usually big and hard to browse in an efficient manner. This often leads to students making errors when choosing classes, possibly choosing wrong classes and sometimes choosing insufficient classes for their required credit. Students would usually use a piece of paper, pencil and eraser and slowly try to build their schedule, calculating and recalculating credits as they make changes. There is no easy way to efficiently search the school provided files by categories, credits and prerequisites. These files usually span a few dozen pages and are usually provided without any index or table of contents.

When the student is done with the process, the completed schedule is usually sent to the school's counselor for review which means possibly more manual changes might be needed.

The above described process usually leads students to perform many mistakes when building the plan. In many cases, students will pick something that is good enough as they are very reluctant to keep iterating through this process. This suboptimal process makes it very hard for the student to focus on his goals and maximize his educational potential. The student will miss important classes and might also fail to meet course requirements.

### SUMMARY OF THE INVENTION

The present invention includes a planner software which allows the user to add and remove classes, track GPA, input grades, track school and university credits, and verify the plan meets certain predefined criteria. The user can send information to a counselor or other school staff member to assist the user with the plan. The app acquires data from of a school-provided pdf (or any other file format resides on the school's website) and organizes it so the users can search for classes and schedule them in a desired slot in a particular time, term and year. The app notifies the user if there is anything wrong or incorrect the plan, what subjects the user needs to complete and what the app recommends the user to take.

The software comprises user interface elements directed toward operations to be performed by a student, and user interface elements directed toward operations to be performed by a counselor, which may be referred to as a “student interface” and a “counselor interface,” respectively. The operations performed by students and counselors are discussed more fully below.

The present invention comprises a novel process that transforms educational institutions' (such as schools', colleges', or universities') class schedule information in the form of plain files into a new software application. This new software application reads the school's provided information and introduces a new User Interface to add/remove/modify school's classes, search through the available classes by name/category/grades/and more, automatically tracks a student's GPA (weighted and unweighted), inputs and tracks grades, tracks school and university credits, automatically syncs up with any school's schedule changes and validates your schedule by providing notifications for any errors, insufficient credit and more. In addition, this new software application streamlines the process of student/counselor feedback by providing the ability to electronically send the student's class schedule data to the school's counselor and provides the option for the counselor to electronically send back a corrected schedule to the student.

Using the application will typically have the following steps: The app first takes a document, which may be in PDF, Word, TXT, JSON, or other format, from a website domain. After fetching the document, it parses it and organizes the data into internal data structures. Now, the user can select a time/term/year of class slot in which they would like to insert a class. Then, the user is able to search for a class name using an advanced search bar. After the user locates and selects the desired class, they are given extra information about the class that helps them decide whether or not the user would like to include the class. Once the class is added, it is automatically saved onto the system locally (internal phone storage/local web browser storage). The app is also consists of “Credits” and “Verify Courses” interfaces and corresponding procedures that help the user organize and pick the required classes. The credits interface tells the user their completion in each subject the school offers, and how many credits they need until the subject is complete. The user can also see the credits they need in order to apply to a UC/CSU college on the “University Credits” interface. The “verify courses” interface takes a list of everything the user must have in their agenda, checks to see if the user has completed each task, and outputs warnings to the user if they have not completed one of the required tasks. This validation is done using predefined rules in the application/system. After the student has completed their academic class, they are now able to enter their grades onto the application. They select the class they want to input a grade into, and then select their grade. Once the user goes onto the GPA section of the app, the app quickly averages the grades and tells the user their unweighted and weighted GPA. The apps information auto updates if the school's classes change or if a new school year begins. The app also includes a “homepage”/“main page” which has notifications and reminders that the user can scroll through. The application has some of these home notifications saved locally. The other notifications are created when the application fetches another document hosted online, parses it, and organizes the text into notifications. This allows the application's reminders on the primary screen of the application to auto-update without the user having to go to the app store to manually update the app (i.e. this is a feature of live updates of school-related notifications fetched from the cloud).

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a diagram showing the general flow of inputs and outputs of an application of the present invention;

FIG. 2 is a diagram showing an overview of the interaction of hardware and software components of the present invention;

FIG. 3 is a flowchart diagram of the process of using the application component of the present invention;

FIG. 4 is a sequence diagram of the basic steps involved in the method of the present invention;

FIG. 5 is a diagram of the memory layout of a user's profile and planned curriculum as set up in preferred embodiments of the application component of the present invention;

FIG. 6 is a flowchart showing a general overview of the process performed by the parser;

FIG. 7 is a user interface layout of the application component of a preferred embodiment of the present invention, showing the presentation of informational items to the user;

FIG. 8 is a user interface layout showing the presentation of items to be corrected after a failed validation check of the user's input of classes;

FIG. 9 is a user interface layout showing user input elements for the selection of a year for class planning;

FIG. 10 is a user interface layout showing user input elements for selecting class slots;

FIG. 11 is a user interface layout showing user input elements for entering grades for a class and removing a class;

FIG. 12 is a user interface layout showing the presentation of the user's weighted and unweighted grade point average to the user;

FIG. 13 is a user interface layout showing the presentation of motivational elements of the application of a preferred embodiment of the present invention;

FIG. 14 is a user interface layout showing the presentation of earned and required university credits to the user;

FIG. 15 is a user interface layout showing the presentation of earned and required credits to the user;

FIG. 16 is a user interface layout showing user input elements for the selection of a school;

FIG. 17 is a user interface layout showing user input elements for sending a plan to a counselor and for opening a plan received from a student;

FIG. 18 is a user interface layout showing user input elements for searching and selecting classes;

FIG. 19 is a user interface layout showing an alternate preferred embodiment of sending class schedule plans from a student to a counselor; and

FIG. 20 is a user interface layout showing a class ratings feature.

### DETAILED DESCRIPTION

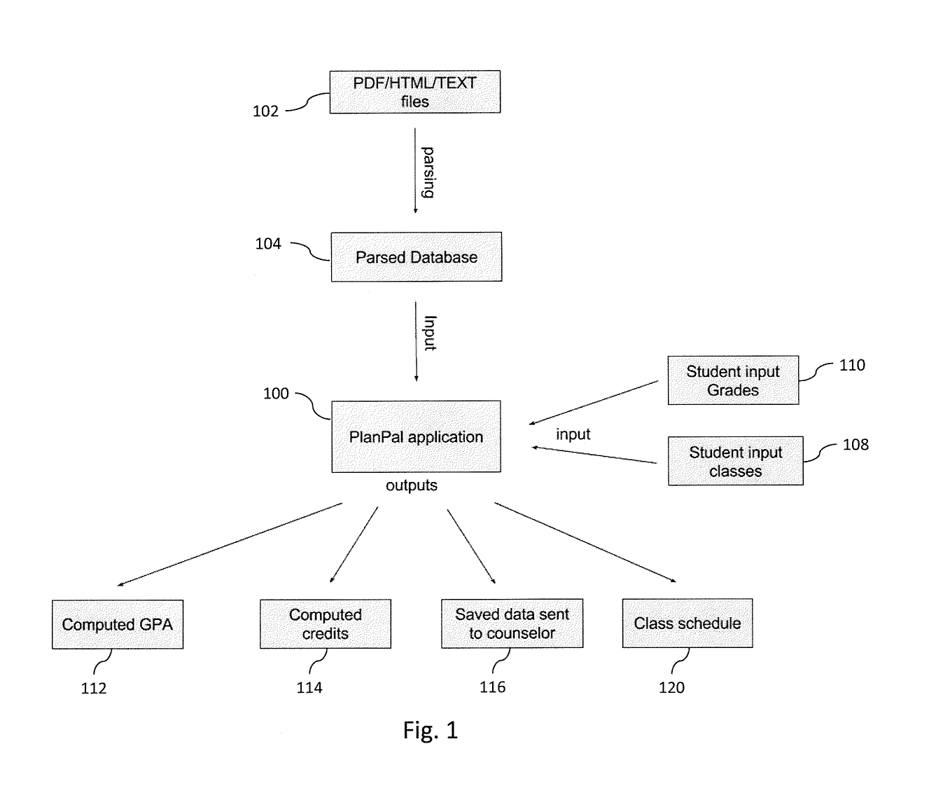

Referring initially to FIG. 1, an overview of the inputs and outputs of an application 100 of the present invention is shown. In a preferred embodiment of the present invention, multiple applications 100 are provided for various platforms. More particularly, in a preferred embodiment, applications 100 are provided for popular mobile operating systems, such as iOS and Android operating systems, and for web browsers. Each application 100 generally includes the same functionality, regardless of its platform.

An application 100 retrieves a class schedule 102 from a school's website. The class schedule 102 is generally provided by the school in an original format designed for presentation to a human end user, such as a PDF, HTML, or plain text format. Although ready for presentation in a human-readable format, the class schedule 102 in its original format cannot be efficiently processed by a computing device. In order to improve the efficiency of the user's mobile device or computer in handling the class schedules, the application 100 parses the class schedule 102 in its original format and transforms the data in the class schedule 102 into a parsed database 104 which comprises a set of data structures optimized for processing by a computing device.

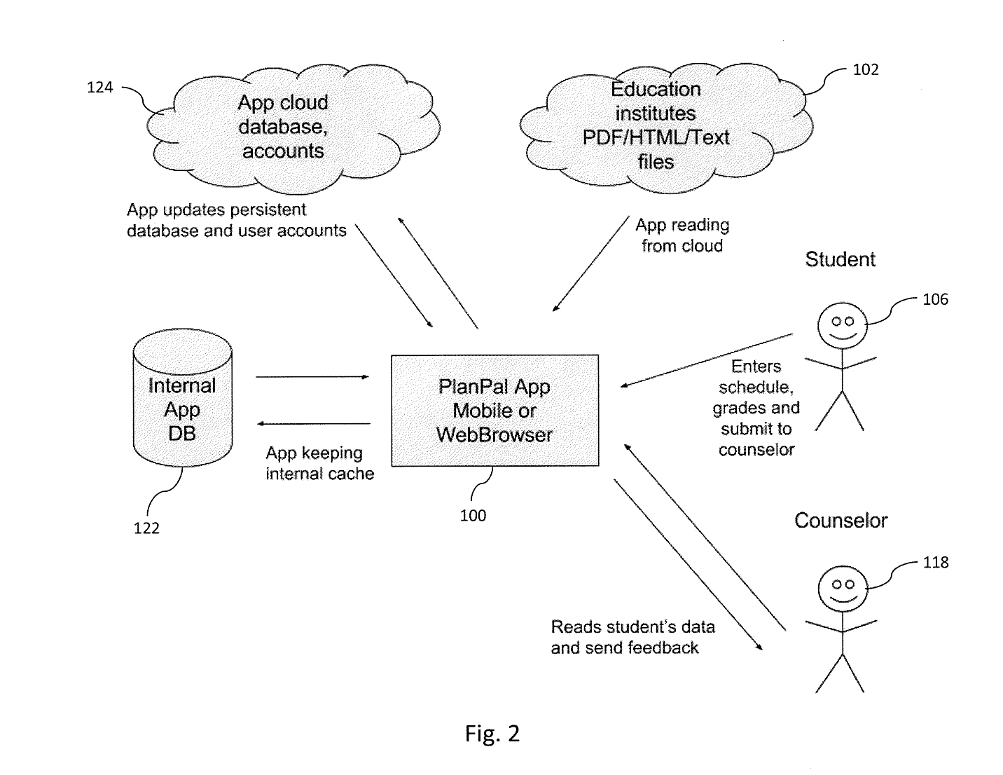

The application's user, generally a student 106 (shown in FIG. 2), selects a set of courses presented by the application 100 after retrieval from the parsed database 104. The selected classes 108 are input into the application 100. Upon completion of a course or courses, the student enters the grades 110.

Based on the data from the various inputs, the application provides the student's grade point average (GPA) 112, earned and in-progress credits 114, data 116 for sending to a counselor 118 (shown in FIG. 2), and a student class schedule 120. The GPA 112 is calculated as both weighted and unweighted GPAs. In a preferred embodiment, unweighted GPA is calculated by assigning the values A=4, B=3, C=2, D=1, and F=0 to the grades, and averaging the value of the grades corresponding to the student's earned credits. In the same embodiment, weighted GPA is calculated in the same manner as unweighted GPA, except with the following assigned values for classes designated as “Advanced Placement” (“AP”): A=5, B=4, C=3, D=2, F=0. Other embodiments may use different grading scales or different value assignments based on a specific region's manner of calculating GPA. Credits 114 include both high school and university credits. University credits are those credits that high school students planning to attend certain universities or colleges are required or strongly encouraged to complete while in high school. These credit requirements may vary by region or other factors. When student class data 116 is sent to the student's counselor 118, the application creates a backup, or “snapshot” of the data so that the student's class schedule can be altered and reverted as desired. The student class schedule 120 comprises those courses from the class schedule 102 selected by the student and/or the student's counselor for the student to take in an upcoming term, as well as courses taken in the current term and in past terms.

Referring now to FIG. 2, the application 100 acquires input from the class schedule 102 of a school's website, the student user 106, and indirectly from the student's counselor 118 as discussed further below. The class schedule 102 is transformed into a parsed database 104, which is stored along with the inputs from the student 106 and the counselor 118 in an internal database 122 on a non-transitory storage medium. Often the non-transitory storage medium will comprise solid-state memory such as flash memory, as is common in mobile devices, but could comprise a hard drive or other form of non-transitory storage known in the art, whether the application 100 is running on a mobile device, in a web browser, or in some other fashion. When the application 100 is in use, some or all of the stored data is also maintained in a working memory comprising transitory storage, usually random access memory (RAM) of the user's mobile device or computer.

An internet-connected, server 124 also maintains a database consisting of user accounts and data provided by the application 100. More particularly, the application 100 provides a copy of the stored data to the server 124, and is capable of receiving stored data associated with the user's account from the server 124. By storing a copy of the data on the server 124, the student 106 is able to send the student class schedule 120 to the counselor 118 and retrieve an altered class schedule prepared by the counselor 118. Another benefit of storing the data on the server 124 is that if the user acquires a new mobile device, or desires to alternate between use of a mobile device and a web browser, the stored data can be retrieved by various instances of the application 100.

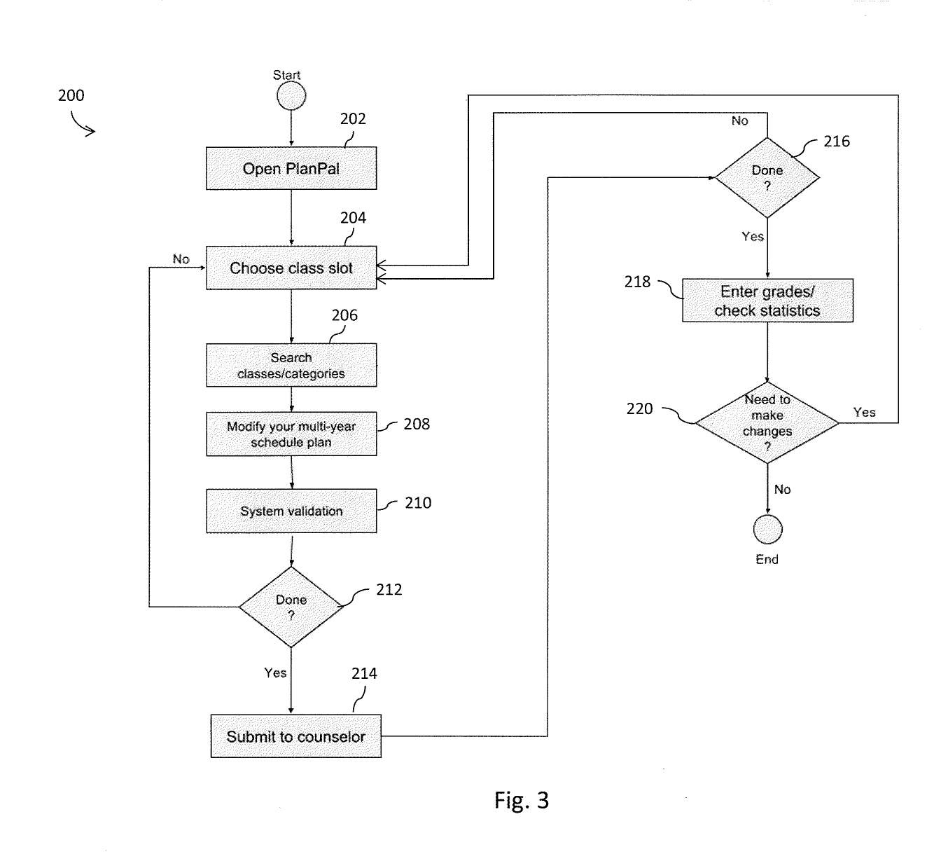

Referring now to FIG. 3, an overview of the process of using the application component of the present invention is shown and generally designated 200. The basic procedure comprises the steps of opening 202 the application; choosing 204 a class slot, or a time slot allocated to classes; searching 206 classes or browsing categories to select a class for the chosen class slot; modifying 208 the student's schedule plan; and validating 210 the modifications to the schedule to make sure all rules, such as prerequisites, are met. The validation step 210 is performed by the application 100, and the user is directed to make any necessary corrections before continuing. Steps 204 through 210 are repeated until the student 106 is finished 212 preparing a student class schedule 116. The student 106 then submits 214 the proposed student class schedule 120 to a counselor 118, who can then make any changes or recommendations to the student 206. If further changes to the student class schedule 120 are necessary or desired, the student 206 is not finished 216 and returns to the choosing step 204. Otherwise, the student enters grades 218 upon completion of the scheduled courses. If and when changes 220 are necessary, the process is repeated.

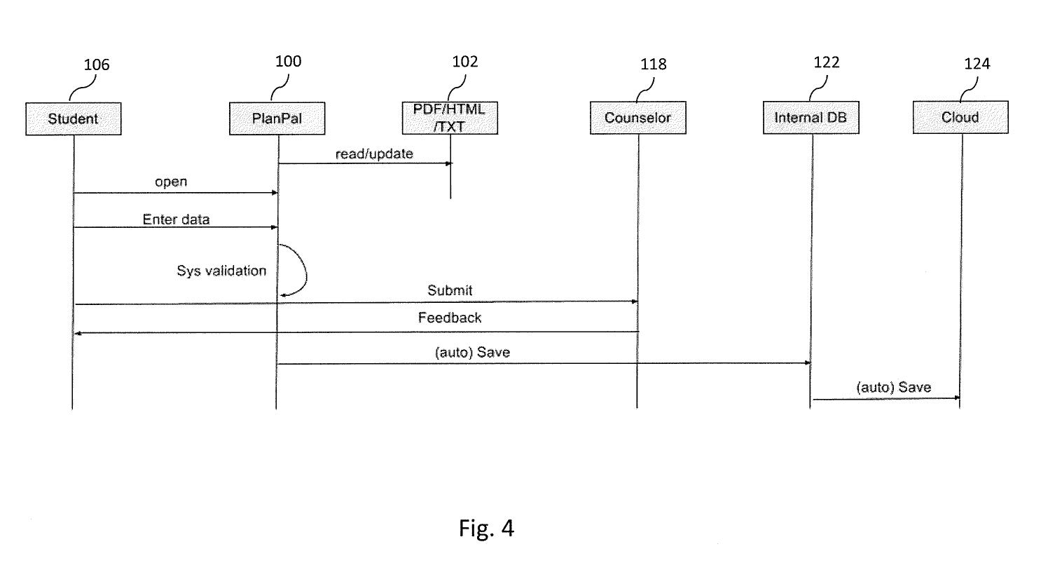

Referring now to FIG. 4, the general process of the present invention is shown as it relates to the interaction of the components of the invention. First, the application 100 obtains a class schedule 102 from the school website and parses the class schedule into a more efficient format for processing. When the student 106 opens the application 100, the student 106 selects a set of classes and prepares a student class schedule 120. The application 100 validates the student class schedule 120 and makes sure any applicable rules are complied with. The student 106 then submits the student class schedule 120 to a counselor 118. Submission of the student class schedule 120 to a counselor 118 is performed by interacting with the interface of the application 100 in order to trigger a procedure in the application 100 which provides a copy of the application's stored data to the internet server 124 and requests that the internet server 124 send a notification to the counselor 118 to retrieve the student class schedule 120 from the internet server 124. Through a similar process, the counselor 118 sends feedback to the student 106. At regular intervals, the application 100 automatically saves the data in its working memory to its internal database 122. Also at regular intervals, the application 100 saves the data in its internal database 122 to the internet server 124.

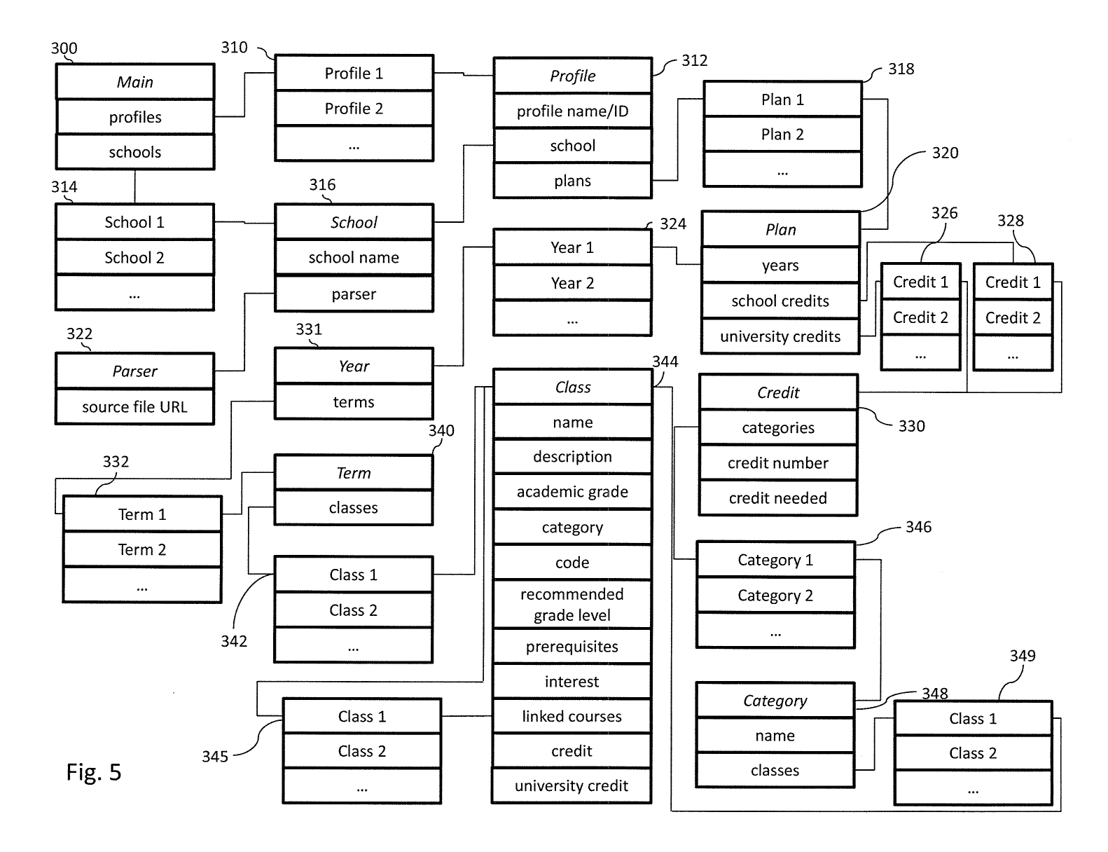

Referring now to FIG. 5, the data structures used by the application 100 in preparing students' planned schedules is outlined. As used in the following discussion of FIG. 5, “structure” may refer to a data structure identified by the “struct” keyword in various programming languages, or any other suitable data structure such as a class, hash table, dictionary, list, or other data type known in the art, including user-defined types. In a preferred embodiment, the “struct” keyword is used to define the structures presented below in working memory. As used in the following discussion of FIG. 5, “array” may refer to an array, or to any other suitable data type such as lists, including linked-lists, vectors, or other data type known in the art, including user-defined types.

Although the data structures are discussed as outlined in working memory, an analogous structure is used for storage of the same data in the application database 122 in a non-transitory storage medium. In a preferred embodiment, the application database 122 uses at least one table for each structure and array, and may be further normalized into additional tables according to generally accepted practices in the art.

A primary data structure 300 used by the application 100 is labeled “Main” in FIG. 5, and comprises an array 310 of profiles 312 and an array 314 of schools 316. The profile structure 312 comprises a profile identifier, which in turn comprises a name, a school 316, and an array 318 of plans 320. The school structure 316 comprises a school name and a parser 322. The parser structure 322 comprises a URL identifying a source file, usually from a school's website, from which to parse class schedule data.

The plan structure 320 comprises an array 324 of years 326, an array 326 of school credits, and an array 328 of university credits, the latter two arrays both comprising credit structures 330.

The year structure 331 comprises an array 332 of terms 340. The term structure 340 in turn comprises an array 342 of classes 344, effectively storing the planned student class schedule 120 for the term corresponding to the instance of the term structure 340. The class structure 344 comprises a name of the course; a course description; a grade (entered upon completion of the course); a category, such as “English” or another general subject; a code corresponding to a school's identifier for the class; a recommended grade level; prerequisites; student interest in the class, if provided in the class schedule parsed by the application 100; linked courses, which may be an array 345 of references to related courses; the number of credits of the class; and university credit, if any, associated with the class. It should be noted that the “category” in the class structure 344 may be implemented as a string rather than a category structure 348, for simplicity, although both implementations are fully contemplated herein. Alternatively, the category in the class structure 344 may be an identifier, such as a numeric identifier, corresponding to an entry in a list of categories. Use of a numeric identifier for the category in the class structure would be an appropriate part of normalization of the application database 122 and the database on the internet server 124, although in some embodiments a simple string is used for efficiency (in the sense of prioritizing speed of access over perfect normalization of the database).

The credit structure 330 comprises an array 346 of categories 348, a number identifying the actual credit achieved by the student 106, and a number of credits necessary for graduation. The category structure 348 comprises a string representing the name of a category of subject matter, such as “English,” or “Mathematics.” Additionally, the category structure 348 may include an array 349 of classes associated with the category.

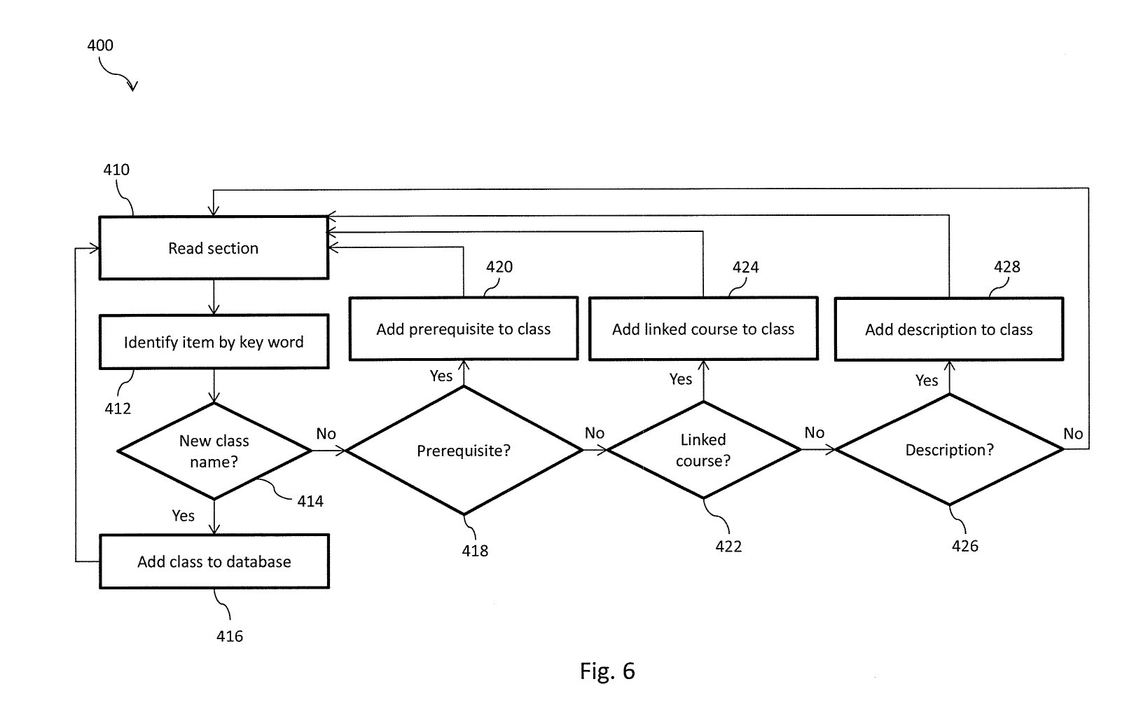

Referring now to FIG. 6, a general overview of the process performed by the parser in order to create parsed database 104 from the class schedule 102 is shown and generally labeled 400. The parser reads a section 410 of the raw class schedule and looks for key words to identify what is being read 412. If a new class name is identified 414, the parser adds the class 416 to the parsed database 104 and loops back to the reading step 410. If a prerequisite is identified 418, the parser adds the prerequisite 420 to the previously identified class, and loops back to the reading step 410. If a linked course is identified 422, the parser adds the linked course 424 to the previously identified class, and loops back to the reading step 410. If a course description is identified 426, the parser adds the description 428 to the previously identified class and loops back to the reading step 410. The decision process continues based on any additional key words that may be used by the parser before looping back to the reading step 410 if an item is unidentified.

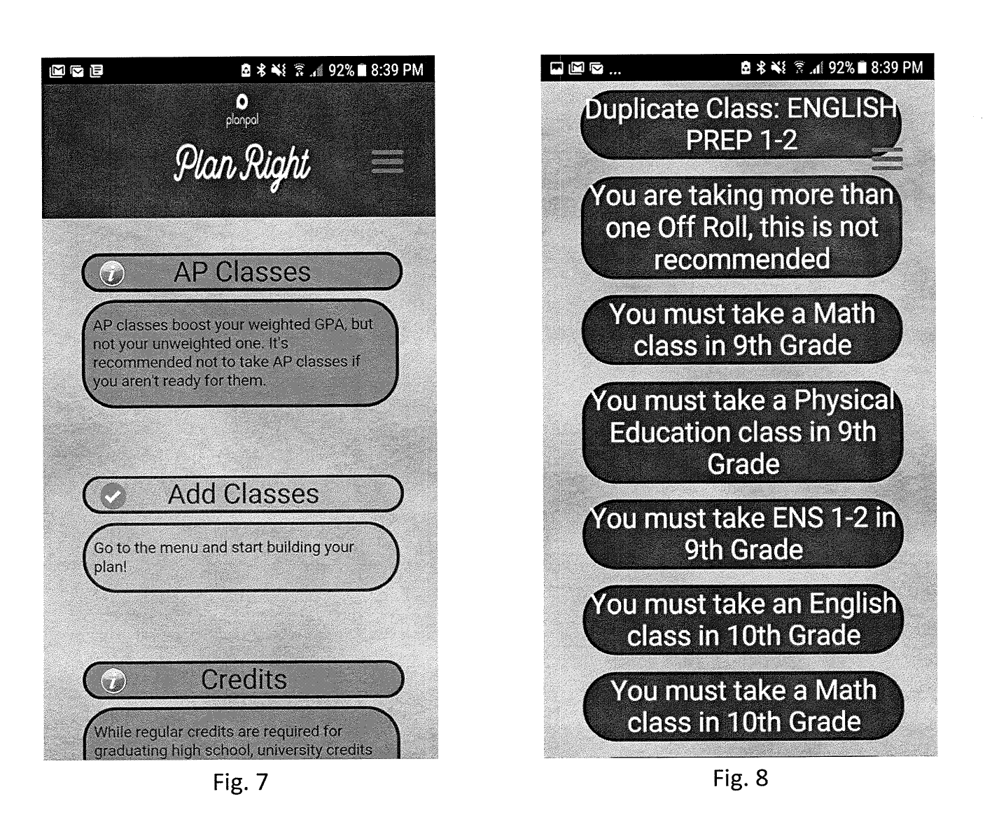

Referring now to FIGS. 7 through 20, various aspects of the user interface of a preferred embodiment of the present invention are shown. Although the user interface elements are shown as they might appear in a mobile application, analogous elements are present in a web browser presentation also. The elements may be combined and adapted in various ways as appropriate for the presentation format. For example, a larger number of elements may be simultaneously visible on a webpage from a computer. The web application may also adapt to the size of the display in the web browser, resulting in a similar appearance to that shown in FIGS. 6-17 when viewed in the browser of a mobile device, and a distinct appearance comprising the display of a larger number of elements at a time when viewed on a computer.

As shown in FIG. 7, the user may be presented with informational material describing the use of the application 100 and tips related to credits, graduation requirements, and other academic and planning matters. Such information may be provided on a home screen, in one or more help pages, at various appropriate points during the process of using the application, or a combination of the foregoing.

As shown in FIG. 8, the application 100 advises the user of relevant requirements and rules when validation step 210 identifies problems with the user's entered schedule.

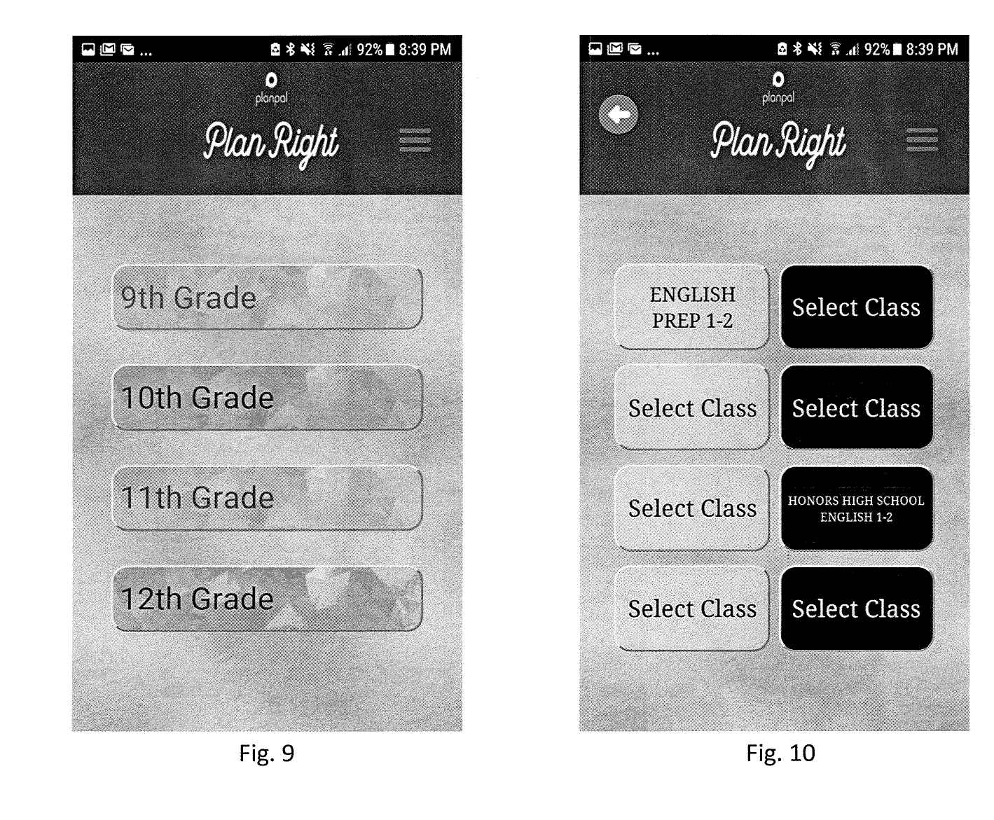

As shown in FIG. 9 and FIG. 10, the application 100 provides user input elements for selecting a grade and selecting class slots for the entry of classes. Through the user input elements, the user may prepare a plan for one or more years of high school, up to all the years of high school. Although four years are shown in FIG. 9, another number of years, such as three or five, may appear as user input options based on the region and school system of the user. The class slots of FIG. 10 may be shown in response to the user's selection of a year from the interface shown in FIG. 9, and will show existing planned courses for the selected year as well as allow the addition or modification of courses in the selected year.

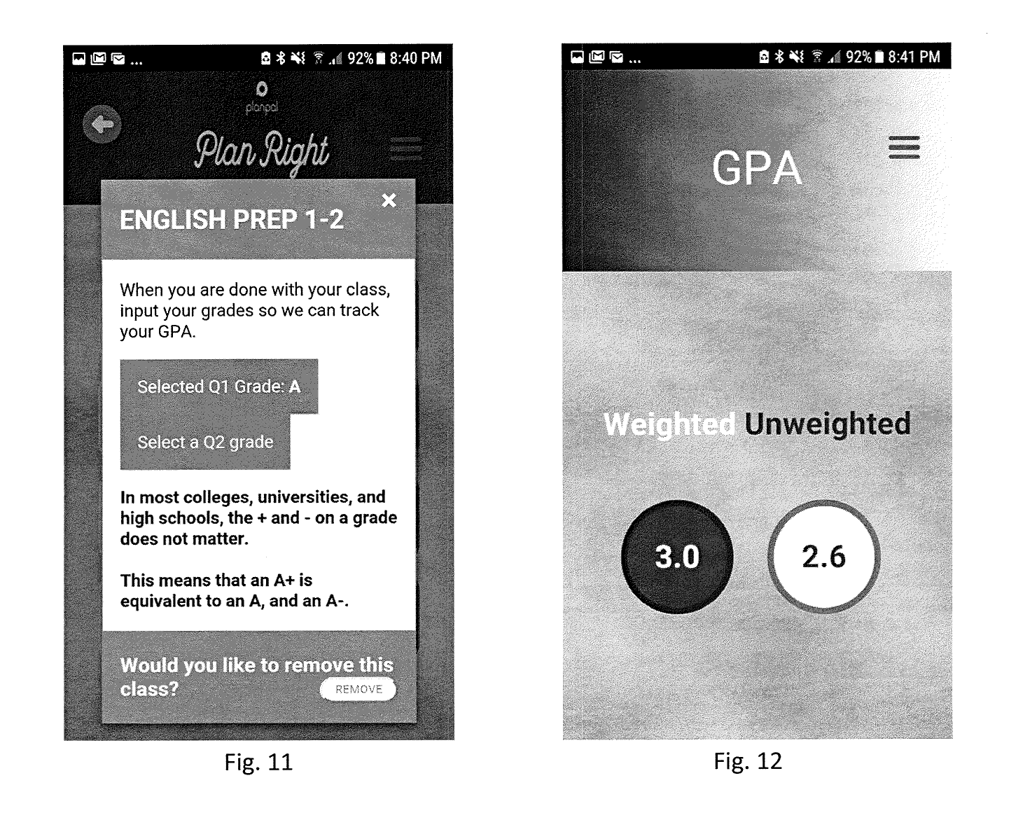

As shown in FIG. 11, after a class is selected and entered into the user's plan, the user may later return to the class to add a grade, or multiple grades for a course spanning multiple terms, or to remove the course from the user's schedule.

Referring now to FIG. 12, the application 100 also calculates the user's grade point average (“GPA”) based on the entered grades, and displays the GPA at the user's request as a weighted and unweighted GPA.

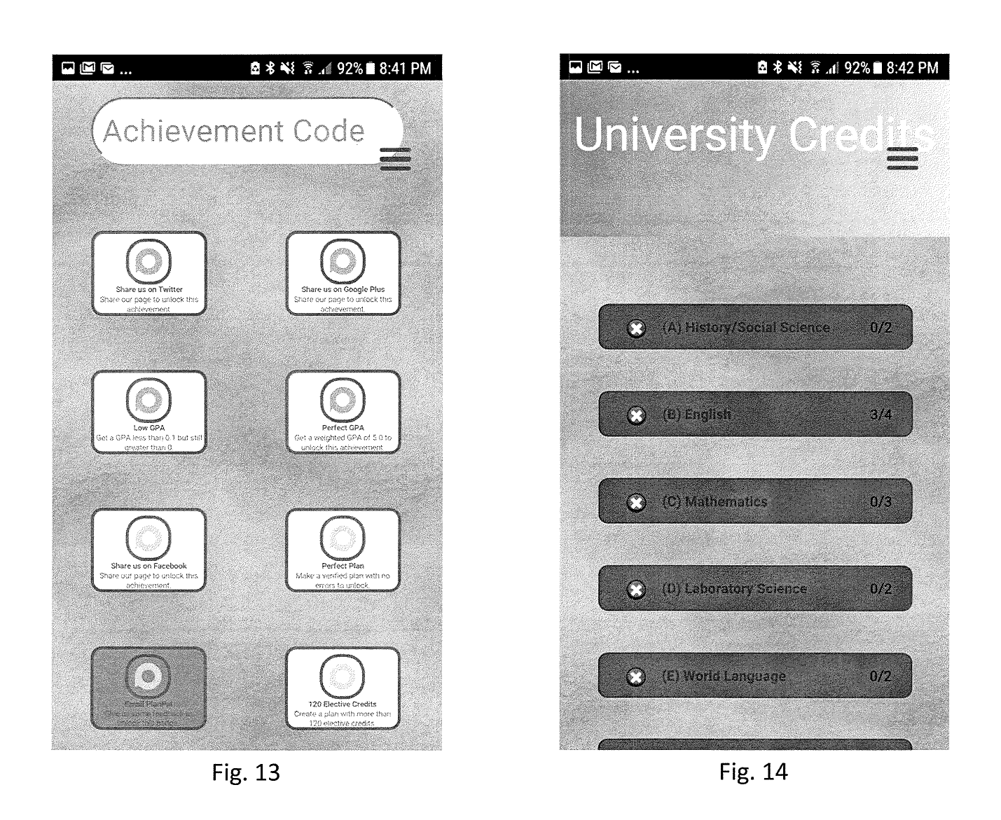

Referring now to FIG. 13, the application 100 may provide motivational elements to the user for completing certain tasks or achieving certain goals. Motivational elements such as reward elements like “achievements” and “badges” also provide an entertaining side to the application 100 and increase the likelihood that a user will complete certain tasks. Reward elements may be provided for certain social media activities, for achieving a certain GPA, for completing certain credits, for preparing a plan meeting certain requirements, for providing feedback on the application 100, rating or commenting on classes (see FIG. 20), for meeting other goals or completing other activities, or for any combination of the foregoing.

As shown in FIG. 14, the application 100 may show the user a list of university credits, including the number of credits achieved and the number required. Additional user interface elements may allow the user to quickly see completed and outstanding requirements. For example, the descriptions of outstanding (incomplete) credit requirements may be displayed in red with an “X” icon to one side, while the descriptions of completed requirements may be shown in green with a check mark icon to one side.

An example of university credits shown in FIG. 14 are the “a-g” requirements of California, which comprises a list of subjects, each with a corresponding number of credits required for completion by a student who wishes to enter a university in the University of California system. The university credits interface may provide different requirements depending on the user's region or goals.

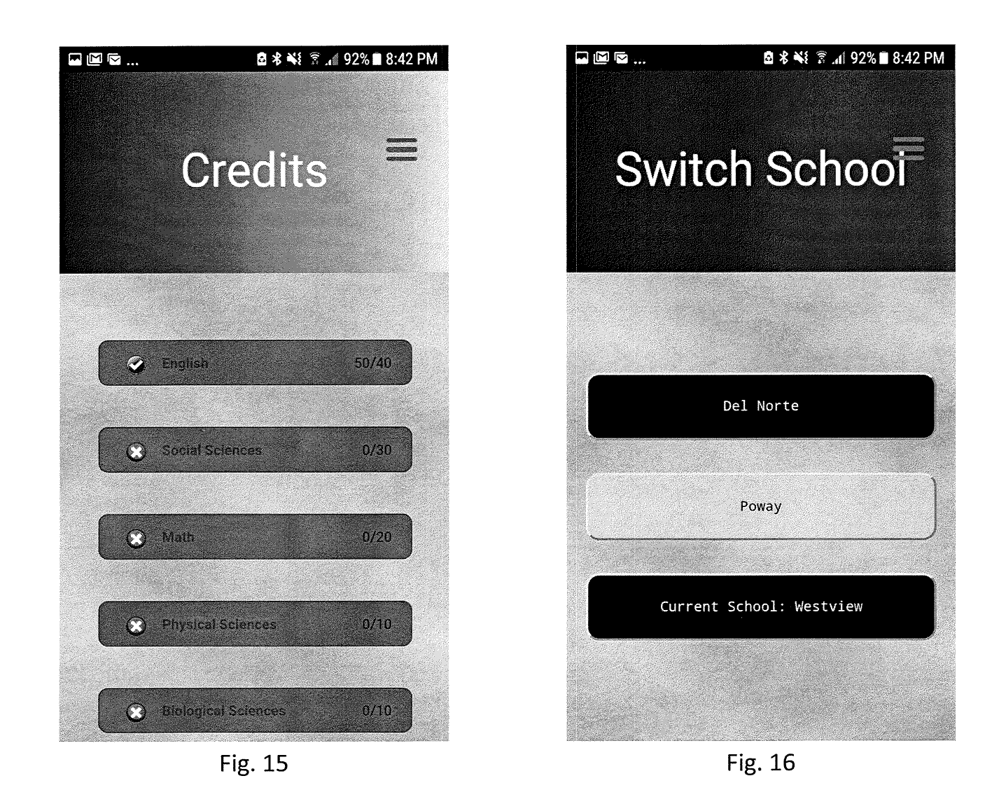

Referring now to FIG. 15, the application 100 may show the user a list of credits required for graduation, including the number of credits achieved and the number required. As with the University Credits interface, additional user interface elements may allow the user to quickly see completed and outstanding requirements. For example, the descriptions of outstanding (incomplete) credit requirements may be displayed in red with an “X” icon to one side, while the descriptions of completed requirements may be shown in green with a check mark icon to one side.

As seen in FIG. 16, the application 100 may provide the user with a way to select a school. FIG. 16 shows a set of buttons corresponding to schools. However, it is contemplated that other types of user interface elements may be used for the same purpose, such as lists, drop-down lists, search features, or other appropriate user interface elements.

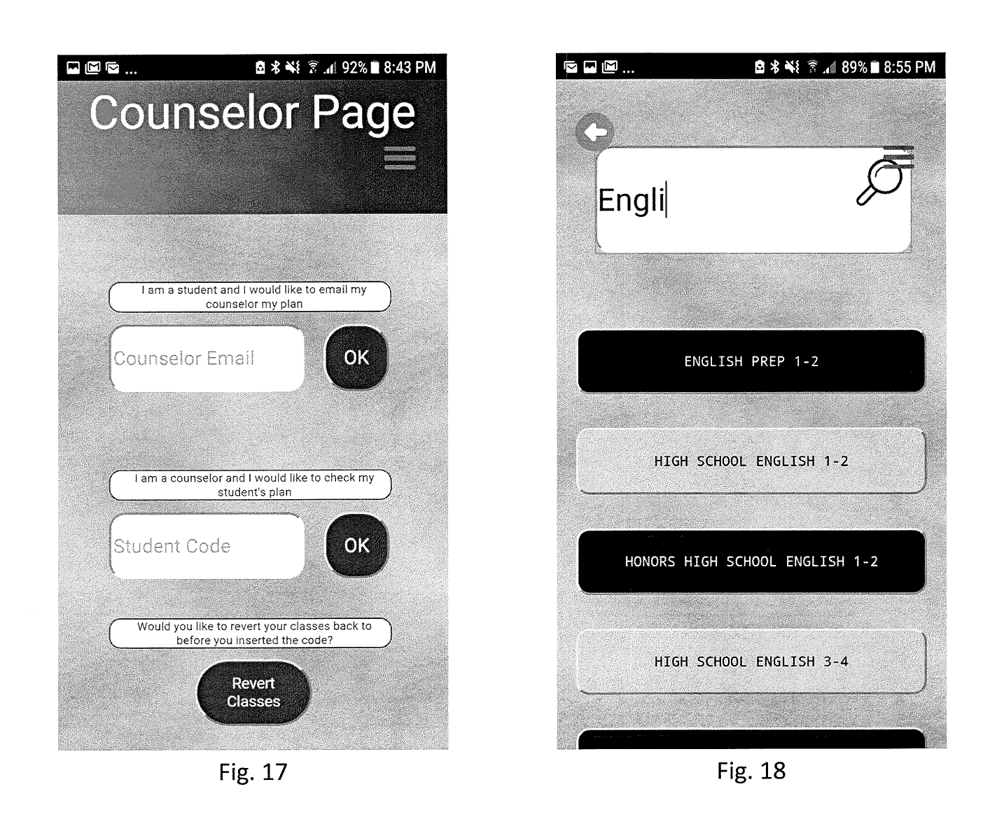

Referring now to FIG. 17, the application 100 provides a way to send a student's plan to a counselor, and for a counselor to retrieve a student's plan. In a preferred embodiment, the user enters the counselor's email address, and a code is sent to the counselor. When the counselor receives and enters the code into another instance of the application 100, the application 100 retrieves the student's plan from the internet server 124, and the counselor is able to make or suggest changes to the students plan and send a revised plan back to the student. In a preferred embodiment, this is also accomplished by sending a code which is entered by the student. When a schedule is modified by entry of a code, the user may revert those changes through another user input element such as a button. In another preferred embodiment, both counselor and student receive links instead of codes, which allow for access to the sent plan without entering a code. Codes may also be provided as an alternative in case the user (counselor or student) is unable to use the link, or wishes to open the plan on a separate computing device from the one in which the email is viewed. It is also fully contemplated that other features capable of transferring a plan may be provided, such as transferring a plan through a feature for direct messaging between students and counselors in the application 100 itself.

Referring now to FIG. 18, one of the benefits of transforming the class schedule 102 into a parsed database 104 is that the transformation provides a memory layout of the class schedule that allows efficient processing of the schedule by a computing device running the application 100. In particular, items from the class schedule can be looked up by entry of a keyword rather than looking through a list of pages trying to spot and recognize a specific item. Then references to a specific class can be specifically made in working memory or non-transitory memory, or data corresponding to a specific class can be copied into working memory or non-transitory memory. Thus a planned student schedule 116 can be efficiently prepared. Accordingly, the application 100 provides a search feature allowing for the user to look up classes and select them for entry into the student class schedule 116. The search interface shown in FIG. 18 may be displayed in response to a student selecting a class slot from the interface shown in FIG. 10.

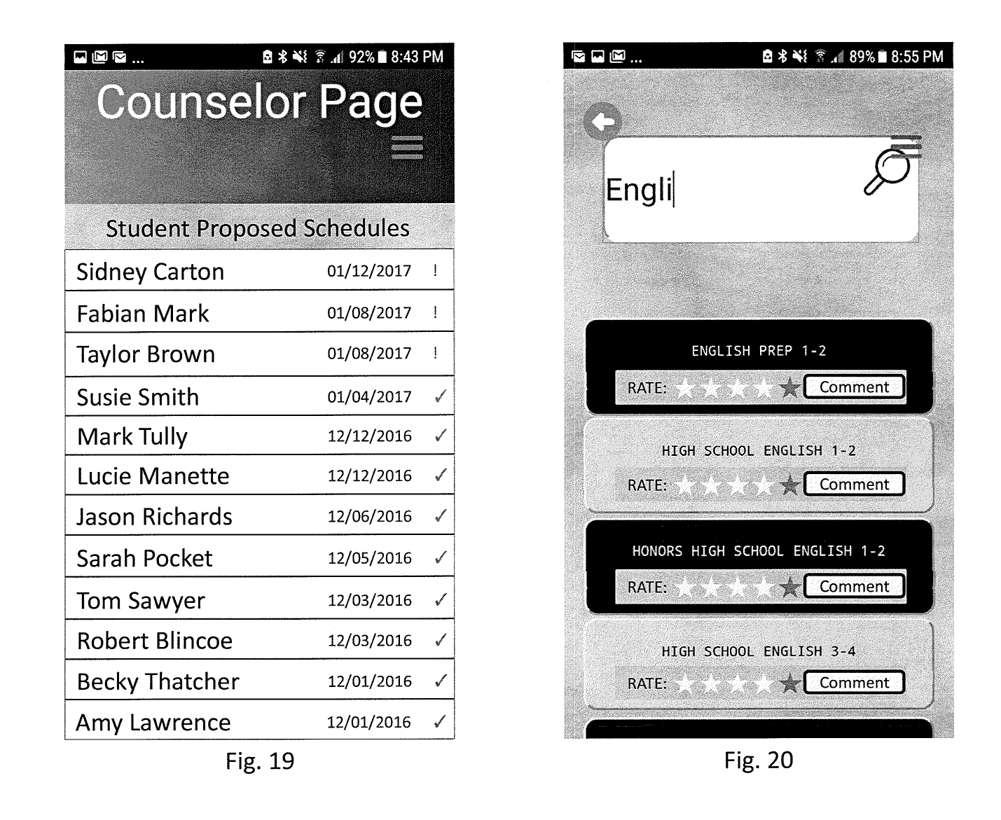

Referring now to FIG. 19, a preferred embodiment of a cloud integrated school scheduling system allows students to be assigned to counselors at their school, avoiding the need to manually enter a counselor email address or send a code in order for a counselor to access a student's plan. A dashboard, as illustrated in FIG. 19, displays a list of students assigned to the counselor, along with basic data such as the date the student saved a new or updated plan to the internet server 124, and an indicator showing whether the student has reviewed the plan. The indicator is shown as an exclamation point for an unreviewed plan, and a checkmark for a reviewed plan, for illustrative purposes, but the indicator may take other forms, such as a varying background color, icons, or some other manner of drawing the counselor's attention to unreviewed plans. By engaging the user interface in a predetermined manner such as, for example, tapping on a student's name, a counselor is able to access, review, and update a particular student's plan.

Referring now to FIG. 20, a user interface for rating classes provides an additional social element for students. A student conducts a search for a class and is shown a user interface element with an overall rating for each class matching the search. The student may engage the user interface element to provide the student's own rating, make a comment, or view other students' comments regarding the class.

While there have been shown what are presently considered to be preferred embodiments of the present invention, it will be apparent to those skilled in the art that various changes and modifications can be made herein without departing from the scope and spirit of the invention.

What is claimed is:

1. A cloud integrated school scheduling system, comprising:
an application, comprising a user interface and an internal database;
an internet server comprising a database; and
an external class schedule,
wherein the application is configured to access and parse the external class schedule into a parsed course schedule,
wherein the user interface is operable by a student to select one or more classes from the parsed course schedule to form a planned class schedule,
wherein the application is configured to save the planned class schedule to the internet server, and
wherein the user interface is operable by a counselor to acquire the planned class schedule from the internet server and display the planned class schedule.

2. The cloud integrated school scheduling system as recited in claim 1, wherein the user interface is operable by the counselor to send feedback on the planned class schedule to the student.

3. The cloud integrated school scheduling system as recited in claim 1, wherein the user interface is operable by the counselor to prepare and send a revised class schedule to the student.

4. The cloud integrated school scheduling system as recited in claim 1, wherein the application further comprises a set of class schedule rules, and wherein the application is configured to validate the planned class schedule against the set of class schedule rules to generate a validation result.

5. The cloud integrated school scheduling system as recited in claim 4, wherein the user interface is configured to display the validation result to the student.

6. The cloud integrated school scheduling system as recited in claim 4, wherein the set of class schedule rules comprises class prerequisites.

7. The cloud integrated school scheduling system as recited in claim 1, wherein the user interface is operable by the student to add grade information to the planned class schedule.

8. A cloud integrated school scheduling system, comprising:
an application, comprising:
a student interface;
a counselor interface; and
an internal database;
an internet server comprising a database; and
an external class schedule,
wherein the application is configured to access and parse the external class schedule into a parsed database,
wherein the student interface is operable by a student to select one or more courses from the parsed course schedule to form a planned schedule, wherein the application is configured to save the planned schedule to the internet server, and
wherein the counselor interface is operable by a counselor to access and display the planned class schedule.

9. The cloud integrated school scheduling system as recited in claim 8, wherein the application further comprises a set of class schedule rules, and wherein the application is configured to validate the planned class schedule against the set of class schedule rules to generate a validation result.

10. The cloud integrated school scheduling system as recited in claim 9, wherein the set of class schedule rules comprises class prerequisites.

11. The cloud integrated school scheduling system as recited in claim 10, wherein the user interface is configured to display the validation result to the student.

12. The cloud integrated school scheduling system as recited in claim 8, further comprising a parser configured to convert the external class schedule from a raw format to a parsed format for storage in the parsed database.

13. The cloud integrated school scheduling system as recited in claim 12, wherein the raw format comprises a format selected from the group consisting of PDF, HTML, and text.

14. The cloud integrated school scheduling system as recited in claim 12, wherein the parser is configured to recognize key words in order to identify classes and prerequisites.

15. The cloud integrated school scheduling system as recited in claim 14, wherein the parser is configured to use the key words to generate a set of class schedule rules, and wherein the application is configured to validate the planned class schedule against the set of class schedule rules to generate a validation result.

16. A cloud integrated school scheduling system, comprising:
an external class schedule;
a parser configured to build a parsed database using the external class schedule;
an app comprising:
a set of inputs, comprising:
the parsed database,
a student proposed class schedule, and
student grades; and
a set of outputs, comprising:
a computed grade point average,
computed credits,
a saved student proposed class schedule, and
a class schedule.

17. The cloud integrated school scheduling system as recited in claim 16, further comprising one or more user interfaces configured to receive inputs from the set of inputs and display outputs from the set of outputs.

18. The cloud integrated school scheduling system as recited in claim 17, wherein a user interface of the one or more user interfaces is operable by a student to input the student proposed class schedule and the student grades.

19. The cloud integrated school scheduling system as recited in claim 17, wherein a user interface of the one or more user interfaces is operable by a counselor to display the saved student proposed class schedule.

20. The cloud integrated school scheduling system as recited in claim 17, wherein a user interface of the one or more user interfaces is operable by a student to display the computed grade point average and the computed credits.
